(19) United States
(12) Patent Application Publication
(10) Pub. No.: US 2026/0365061 A1
(43) Pub. Date: Nov. 19, 2026

(54) CHARGING SYSTEM FOR A HIGH-VOLTAGE BATTERY OF A VEHICLE AND METHOD FOR CONTROLLING THE CHARGING SYSTEM

(71) Applicant: VOLVO TRUCK CORPORATION, Göteborg (SE)

(72) Inventor: Mats NYSTRÖM, Torslanda (SE)

(73) Assignee: VOLVO TRUCK CORPORATION, Göteborg (SE)

(21) Appl. No.: 19/102,103

(22) PCT Filed: Aug. 16, 2022
(86) PCT No.: PCT/EP2022/072855

§ 371 Date: Feb. 7, 2025

(51) Int. Cl. B60L 53/62; B60L 3/00; B60L 53/16

(52) U.S. Cl. CPC B60L 53/62; B60L 3/0046; B60L 53/16; B60L 2200/44; B60L 2250/00

(57) ABSTRACT

A charging system for charging a high-voltage battery of a vehicle has a charging inlet to be connected to a high-voltage power source; the charging inlet comprising a controllable locking mechanism configured to lock a charging connector to the charging inlet during charging; a high-voltage battery; a charging contactor between a negative pole of the charging inlet and a negative pole of the high-voltage battery; a diode between a positive pole of the charging inlet and a positive pole) of the high-voltage battery. The diode blocks a current from the high-voltage battery to the charging inlet. A first discharge resistor is arranged between the positive pole of the charging inlet and ground. A second discharge resistor is arranged between the negative pole of the charging inlet and ground. A charging system control unit determines that charging is to be aborted; sets a charging voltage of the high-voltage power source to a voltage lower than a battery voltage; opens the charging contactor; and unlocks a charging connector placed in the charging inlet.

### TECHNICAL FIELD

The invention relates to a charging system for an electrical vehicle. In particular, the invention relates to a simplified charging system and method for controlling the charging system when charging is stopped.

The invention is applicable in electrical and hybrid vehicles within the fields of trucks, buses, industrial construction machines and the like. Although the invention will be described with reference to a truck, the invention is not restricted to this particular vehicle, but may also be used in other electric vehicles.

### BACKGROUND

In hybrid and electric vehicles, charging of batteries is an essential function which is expected to be reliable and safe. The inlet of the vehicle charging system used for charging batteries of a vehicle shall according to safety regulations be electrically disconnected when no charging station is connected to eliminate the risk that the battery voltage is present at the charging inlet. For the purpose of disconnection, a contactor is typically used.

To achieve complete galvanic disconnection of the charging inlet, the charging system typically comprise contactors for both the positive and negative pole of the battery. However, with increasing requirements for faster charging, the need to support very high charging currents is growing and contactors that support sufficiently high currents are both bulky and expensive. Moreover, a higher current lead to an increased wear of the contactors each time the contactor is opened or closed which mean that the contactors may need to be replaced more often compared to contactors for lower currents.

Accordingly, there is a need for a simplified charging system for charging a high-voltage battery of a vehicle.

### SUMMARY

An object of the claimed system and method is to provide an improved charging system and method for controlling the charging system during abortion of charging and disconnection of a charger.

According to a first aspect, there is provided a charging system for charging a high-voltage battery of a vehicle, the charging system comprising: a charging inlet configured to be connected to a high-voltage power source; the charging inlet comprising a controllable locking mechanism configured to lock a charging connector to the charging inlet during charging; a high-voltage battery; a charging contactor arranged between a negative pole of the charging inlet and a negative pole of the high-voltage battery; a diode arranged between a positive pole of the charging inlet and a positive pole of the high-voltage battery, wherein the diode is configured to block a current from the high-voltage battery to the charging inlet; a first discharge resistor arranged between the positive pole of the charging inlet and ground; a second discharge resistor arranged between the negative pole of the charging inlet and ground; and a charging system control unit. The charging system control unit is configured to: determine that charging is to be aborted; set a charging voltage of the high-voltage power source to a voltage lower than a battery voltage; open the charging contactor; and unlock a charging connector placed in the charging inlet.

Existing charging systems often comprise two contactors, one for each of the negative and positive pole in order to safely disconnect a high-voltage battery from a charging inlet. However, as discussed in the background section, contactors for high-voltage applications can be both bulky and expensive and are exposed to wear which means that they may have to be replaced after a certain operating time. Accordingly, the present invention is based on the realization that by arranging a diode on the positive pole and by arranging discharge resistors between positive and negative poles and ground, the contactor for the positive pole can be omitted without compromising the safety of the charging system.

According to an example embodiment, the charging system control unit is further configured to determine that a voltage over the charging inlet is below a predetermined threshold voltage before unlocking the charging connector. To ensure that the charging inlet is safe before disconnecting the charging connector, the charging system control unit can determine that voltage over the charging inlet is below a predetermined threshold voltage by waiting for a confirmation from the charging station of from a voltage measuring unit arranged to measure the voltage over the charging inlet.

According to one embodiment of the invention, the charging system further comprises a discharge contactor arranged between each of the first and second discharge resistor and ground. Moreover, the control unit is configured to open the discharge contactor during charging if a current through either of the first and second discharge resistor is above a corresponding predetermined threshold value. Thereby, the discharge resistors are protected in case of excessive reverse leakage currents, i.e. if the resistance values of the discharge resistors are so low so that a significant current would go via the discharge resistors to ground during charging.

According to an example embodiment, the charging system control unit is configured to determine that charging is to be aborted when receiving a command from an operator to abort charging. Charging may also be aborted when the battery is approaching a fully charged state. Other reasons for aborting charging may for example be if charging is scheduled to take place when the overall power consumption in a supply grid is low or when the cost of electricity is low. Accordingly, the charging system control unit may determine that charging is to be aborted in a number of different ways.

According to a second aspect of the invention, there is provided a method for controlling a charging system for charging a high-voltage battery of a vehicle, the charging system comprising: a charging inlet configured to be connected to a high-voltage power source; the charging inlet comprising a controllable locking mechanism configured to lock a charging connector to the charging inlet during charging; a high-voltage battery; a charging contactor arranged between a negative pole of the charging inlet and a negative pole of the high-voltage battery; a diode arranged between a positive pole (116) of the charging inlet and a positive pole of the high-voltage battery, wherein the diode is configured to block a current from the high-voltage battery to the charging inlet; a first discharge resistor arranged between the positive pole of the charging inlet and ground; a second discharge resistor arranged between the negative pole of the charging inlet and ground; and a charging system control unit. The method comprises: determining that charging is to be aborted; setting a charging voltage of the high-voltage power source to a voltage lower than a battery voltage; opening the charging contactor; and unlocking a charging connector placed in the charging inlet.

There is also provided a charging system control unit arranged and configured to perform the above-described method for controlling the safety circuit.

Effects and features of this second aspect of the present invention are largely analogous to those described above in connection with the first aspect of the invention.

Further advantages and advantageous features of the invention are disclosed in the following description and in the dependent claims.

### BRIEF DESCRIPTION OF THE DRAWINGS

With reference to the appended drawings, below follows a more detailed description of embodiments of the invention cited as examples.

In the drawings:

FIG. 1 is a schematic illustration of charging system in a vehicle according to an embodiment of the invention;

FIG. 2 is a flow-chart outlining a method of controlling a charging system of a vehicle according to an embodiment of the invention, and

FIG. 3 is a vehicle comprising a power system according to an embodiment of the invention.

### DETAILED DESCRIPTION OF EXAMPLE EMBODIMENTS OF THE INVENTION

In the present detailed description, various embodiments of a charging system for charging a high-voltage battery of a vehicle according to the present invention are mainly discussed with reference to a charging system in a truck. It should however be noted that this by no means limits the scope of the present invention since the described invention is equally applicable in other types of vehicles such as cars, buses and construction vehicles. The described charging system may also be used in marine applications such as boats and ships, and in other applications comprising a high-voltage battery to be charged.

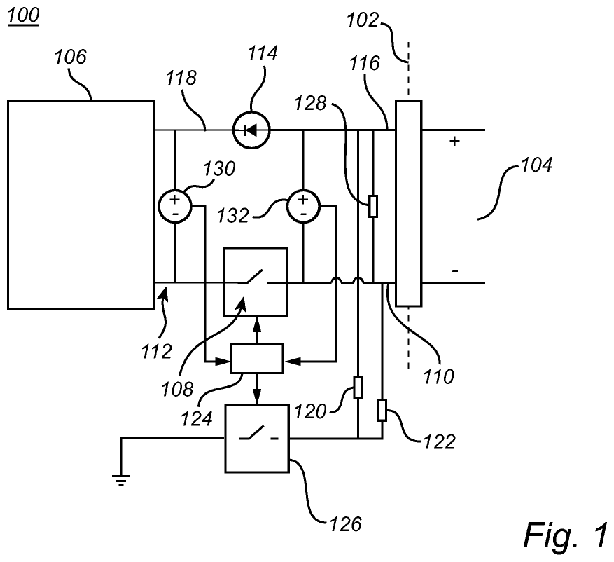

FIG. 1 schematically illustrates a circuit schematic of a charging system 100 for charging a high-voltage battery of a vehicle 300. The charging system comprises a charging inlet 102 configured to be connected to a high-voltage power source 104. The high-voltage power source 104 can be a stationary charging station connected to the power grid, but the power source can also be another power source such as an external battery or a power source in another vehicle. In the following description, the high-voltage power source 104 will generally be referred to as a charging station 104.

The charging inlet 102 further comprises a controllable locking mechanism (not shown) configured to lock a charging connector to the charging inlet 102 during charging to ensure that any component of the charging inlet 102 having a high voltage is protected from touch. In particular, regulations require that the charging system is safe before a charging connector is released. The locking mechanism can be any type of mechanical arrangement for securing a charging connector or charging handle to the charging inlet known to the skilled person.

The charging system 100 further comprises a high-voltage battery 106 and a charging contactor 108 arranged between a negative pole 110 of the charging inlet and a negative pole 112 of the high-voltage battery 106. The contactor 108 is controllable by a charging system control unit 124 to break a connection between the charging inlet 102 and the battery 106 on the negative pole.

The charging system control unit 112 may include a microprocessor, microcontroller, programmable digital signal processor or another programmable device. The control unit may also, or instead, include an application specific integrated circuit, a programmable gate array or programmable array logic, a programmable logic device, or a digital signal processor. Where the control unit includes a programmable device such as the microprocessor, microcontroller or programmable digital signal processor mentioned above, the processor may further include computer executable code that controls operation of the programmable device.

Moreover, the charging system 100 comprises a diode 114 arranged between a positive pole 116 of the charging inlet and a positive pole 118 of the high-voltage battery, wherein the diode 114 is configured to block a current from the high-voltage battery 106 to the charging inlet 102.

The charging system 100 further comprises a first discharge resistor 120 arranged between the positive pole 116 of the charging inlet 102 and ground and a second discharge resistor 122 arranged between the negative pole 110 of the charging inlet 102 and ground. The first and second discharge resistors 120, 122 can be seen as a discharge network arranged to ensure that there is no remaining voltage on the charging inlet 102 when charging has been stopped, i.e. when there is no charging voltage provided by the charging station 104.

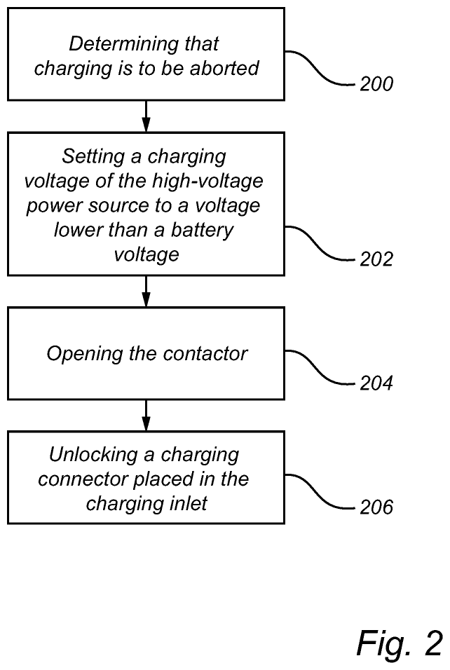

FIG. 2 is a flow chart describing steps of a method for controlling the charging system 100 according to an example embodiment, and the method will be described with reference to the charging system 100 illustrated in FIG. 1.

In a first step, the charging system control unit 124 is configured to determine 200 that charging is to be aborted. The charging system control unit 124 can for example receive a command from an operator that charging should stop or an indication from the battery 106 that the battery is fully charged. Determining that charging is to be aborted can also comprise receiving a command from the charging station. When it is determined that charging is to be aborted, a charging voltage of the high-voltage power source is set 202 to a voltage lower than a battery voltage, for example by sending a command from the charging system control unit to the 124 to the charging station 104.

Once charging is aborted, the charging contactor 108 on the negative pole is opened 204 to disconnect the battery 106 from the charging inlet 102 and the charging connector placed in the charging inlet 104 is unlocked 206 so that the charging connector can be safely removed.

The discharge network, i.e. the first and second discharge resistors 120, 122 are configured so that as soon as the charging station stops providing power, the discharge resistors will be capable of bringing the voltage over the charging inlet down since both charging resistors 120, 122 are connected to ground. The charging system 100 illustrated in FIG. 1 further comprises a first voltage measurement unit 130 arranged to measure a voltage of the high-voltage battery 106 and a second voltage measurement unit 132 arranged to measure a voltage of the charging inlet 104. The second voltage measurement unit 132 can be used to verify that a voltage over the charging inlet 102 is at a safe level before unlocking the charging connector. The charging system control unit 124 can also receive a voltage measurement from the charging station indicating that the voltage over the charging inlet is within safe limits.

The charging system further comprises a discharge contactor 126 arranged between each of the first and second discharge resistor and ground. The charging system control unit 124 is configured to open the discharge contactor 126 during charging if a current through either of the first and second discharge resistor is above a corresponding predetermined threshold value. The isolation resistance, i.e. the resistance of the discharge resistors 120, 122 need to be sufficiently high so that there is no current path through the resistors to ground during charging, and the resistance values of the two resistors are typically the same. However, it would also be possible to have two different resistance values.

The discharge contactor 126 is optional and may be advantageous in applications where it is suspected that a current through the resistors may exceed the current threshold value during charging. In an application where a discharge contactor 126 is used, the discharge contactor is closed when charging is not active, for example when the charging connector is released from the charging inlet 102.

The discharge contactor 126 can also be used if the reverse leakage current through the diode 114 is so high so that low resistance values of the discharge resistors are needed to bring down volte below the required 60VDC.

If the leakage in the diode 114 or stray capacitance discharge timing require so low resistance values that an isolation level under normal operation will be too low, or if the heat and/or losses caused by the parasitic load is of unacceptable magnitude, the discharge contactor may need to be opened.

The charging system of FIG. 1 further comprises a third resistor 128 arranged between the positive pole 116 and the negative pole 110 located between the diode 114 and the charging inlet 102. The third resistor handles any reverse leakage that the diode 114 may have and directs a leakage current to ground.

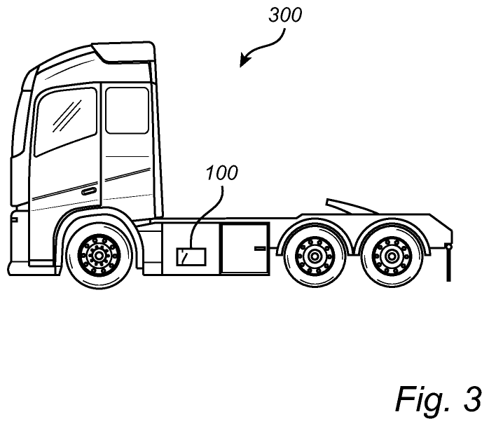

FIG. 3 is a vehicle 300 comprising a charging system 100 according to any of the aforementioned embodiments and examples.

It is to be understood that the present invention is not limited to the embodiments described above and illustrated in the drawings; rather, the skilled person will recognize that many changes and modifications may be made within the scope of the appended claims.

1. A charging system for charging a high-voltage battery of a vehicle, the charging system comprising:
a charging inlet configured to be connected to a high-voltage power source; the charging inlet comprising a controllable locking mechanism configured to lock a charging connector to the charging inlet during charging;
a high-voltage battery;
a charging contactor arranged between a negative pole of the charging inlet and a negative pole of the high-voltage battery;
a diode arranged between a positive pole of the charging inlet and a positive pole of the high-voltage battery, wherein the diode is configured to block a current from the high-voltage battery to the charging inlet;
a first discharge resistor arranged between the positive pole of the charging inlet and ground;
a second discharge resistor arranged between the negative pole of the charging inlet and ground; and
a charging system control unit configured to:
determine that charging is to be aborted;
set a charging voltage of the high-voltage power source to a voltage lower than a battery voltage;
open the charging contactor; and
unlock a charging connector placed in the charging inlet.

2. The charging system according to claim 1, wherein the charging system control unit is further configured to determine that a voltage over the charging inlet is below a predetermined threshold voltage before unlocking the charging connector.

3. The charging system according to claim 1, further comprising a discharge contactor arranged between each of the first and second discharge resistor and ground.

4. The charging system according to claim 3, wherein the control unit is configured to open the discharge contactor during charging if a current through either of the first and second discharge resistor is above a corresponding predetermined threshold value.

5. The charging system according to claim 1, further comprising a third resistor arranged between the positive pole and the negative pole, and between the diode and the charging inlet.

6. The charging system according to claim 1, wherein the charging system control unit is configured to determine that charging is to be aborted when receiving a command from an operator to abort charging.

7. The charging system according to claim 1, wherein the charging system control unit is configured to determine that charging is to be aborted when the battery is fully charged.

8. A vehicle comprising a charging system according to claim 1.

9. Method for controlling a charging system for charging a high-voltage battery of a vehicle, the charging system comprising: a charging inlet configured to be connected to a high-voltage power source; the charging inlet comprising a controllable locking mechanism configured to lock a charging connector to the charging inlet during charging; a high-voltage battery; a charging contactor arranged between a negative pole of the charging inlet and a negative pole of the high-voltage battery; a diode arranged between a positive pole of the charging inlet and a positive pole of the high-voltage battery, wherein the diode is configured to block a current from the high-voltage battery to the charging inlet; a first discharge resistor arranged between the positive pole of the charging inlet and ground; a second discharge resistor arranged between the negative pole of the charging inlet and ground; and a charging system control unit, wherein the method comprises:
determining that charging is to be aborted;
setting a charging voltage of the high-voltage power source to a voltage lower than a battery voltage;
opening the charging contactor; and
unlocking a charging connector placed in the charging inlet.

10. The method according to claim 9, further comprising determining that a voltage over the charging inlet is below a predetermined threshold voltage before unlocking the charging connector.

11. The method according to claim 9, further comprising, after setting the charging voltage of the high-voltage power source to a voltage lower than a battery voltage, closing a discharge contactor arranged between each of the first and second discharge resistor and ground.

12. The method according to claim 11, further comprising opening the discharge contactor during charging if a current through either of the first and second discharge resistor is above a corresponding predetermined threshold value.

13. The method according to claim 9, wherein determining that charging is to be aborted comprises receiving a command from an operator to abort charging.

14. The method according to claim 9, wherein determining that charging is to be aborted comprises determining that the battery is fully charged.

15. The method according to claim 9, wherein setting a charging voltage of the high-voltage power source to a voltage lower than a battery voltage comprises setting the charging voltage to a voltage which is at least 50 V lower than the battery voltage.

16. A control unit for controlling a safety circuit for a power system of a vehicle, the control unit being configured to perform the steps of the method according to claim 9.
